(19) United States
(12) Patent Application Publication
(10) Pub. No.: US 2021/0089195 A1
(43) Pub. Date: Mar. 25, 2021

(54) INFORMATION PROCESSING SYSTEM, INFORMATION PROCESSING APPARATUS, AND NON-TRANSITORY COMPUTER READABLE MEDIUM STORING PROGRAM

(71) Applicant: FUJI XEROX CO., LTD., Tokyo (JP)

(72) Inventor: Kosuke KIKUSHIMA, Kanagawa (JP)

(73) Assignee: FUJI XEROX CO., LTD., Tokyo (JP)

(21) Appl. No.: 16/787,021

(22) Filed: Feb. 11, 2020

(30) Foreign Application Priority Data
Sep. 25, 2019 (JP) 2019-174049

(51) Int. Cl. G06F 3/0484; G06F 3/0486

(52) U.S. Cl. CPC G06F 3/04847; G06F 3/0486

(57) ABSTRACT

An information processing system includes a first information processing apparatus including a first processor configured to receive a creation instruction of representation information representing a storage area used for transferring data, from a first user, and create the representation information in accordance with the received creation instruction, and a second information processing apparatus including a second processor, in which the created representation information includes designation information indicating whether or not to allow another user other than the first user to designate a location of the storage area, the second processor is configured to receive the representation information which represents the storage area used for transferring data and include the designation information indicating whether or not to allow a user to designate the location of the storage area, and, in a case where the designation information included in the representation information indicates that the user is allowed to designate the location of the storage area, the second processor displays a screen for receiving designation of the location and preserves the representation information incorporating information of the location, which is designated on the screen.

### CROSS-REFERENCE TO RELATED APPLICATIONS

This application is based on and claims priority under 35 USC 119 from Japanese Patent Application No. 2019-174049 filed Sep. 25, 2019.

### BACKGROUND

### (i) Technical Field

The present invention relates to an information processing system, an information processing apparatus, and a non-transitory computer readable medium storing a program.

### (ii) Related Art

There is a system of performing a work while transferring data between users through a storage area such as a folder on a network. In this type of system, representation information representing a storage area is registered in a terminal of each user. A representation image such as an icon, which is indicated by the registered representation information is displayed on the screen of the terminal. The user performs a retrieving operation or a preservation operation on the representation image displayed on the screen of the terminal of the user, so as to retrieve data which has been preserved in a storage area corresponding to the representation image by another user or to preserve data to be transmitted to another user in a storage area corresponding to the representation image.

In addition, there is a system in which a certain user creates representation information and transmits the created representation information to the other user, and the other user registers and uses the transmitted representation information in the terminal of the other user.

In this type of system, only in a case where a user who creates representation information designates a storage location represented by the representation information, creating the representation information is possible. In addition, a user who receives representation information from a user who has created the representation information is capable of only registering the representation information as it is in the own terminal.

As an example of this type of system, “DOCUWORKS (registered trademark) TRAY 2” provided by the applicant is known.

A data processing system disclosed in JP4731928B includes a server that stores and manages a plurality of pieces of document data, and a PC as a data processing apparatus that is connected to the server to access predetermined data in the server and perform predetermined data processing. The server generates a shortcut file including shortcut information including DB access information. The PC determines whether or not DB access information is included in shortcut information included in the shortcut file. When the DB access information is included in the shortcut information, the PC establishes a connection to a document DB.

### SUMMARY

A case where a user who receives and uses created representation information may be capable of designating a location of a storage area represented by the representation information is also considered.

Aspects of non-limiting embodiments of the present disclosure relate to an information processing system, an information processing apparatus, and a non-transitory computer readable medium storing a program, in which it is possible to flexibly perform designation of a location of a storage area represented by representation information between a user who creates the representation information and a user who uses the created representation information, in comparison to a case where designation of a location of a storage area is not received from a user who uses representation information representing the storage area.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system includes a first information processing apparatus including a first processor configured to receive a creation instruction of representation information representing a storage area used for transferring data, from a first user, and create the representation information in accordance with the received creation instruction, and a second information processing apparatus including a second processor, in which the created representation information includes designation information indicating whether or not to allow another user other than the first user to designate a location of the storage area, the second processor is configured to receive the representation information which represents the storage area used for transferring data and include the designation information indicating whether or not to allow a user to designate the location of the storage area, and, in a case where the designation information included in the representation information indicates that the user is allowed to designate the location of the storage area, the second processor displays a screen for receiving designation of the location and preserves the representation information incorporating information of the location, which is designated on the screen.

### BRIEF DESCRIPTION OF THE DRAWINGS

Exemplary embodiment(s) of the present invention will be described in detail based on the following figures, wherein:

FIG. 1 is a diagram illustrating an example of a workflow in which a user transmits and receives data through a plurality of storage areas;

FIG. 2 is a diagram illustrating a mechanism of realizing a workflow illustrated in FIG. 1, by transferring data through a tray on a PC screen, which represents the storage area;

FIG. 3 is a diagram illustrating a hardware configuration of a computer that executes an application of a tray service;

FIG. 4 is a diagram illustrating a workflow design screen;

FIG. 5 is a diagram illustrating an edit button of the tray on the workflow design screen;

FIG. 6 is a diagram illustrating a processing procedure of the application when an instruction to edit the tray is made;

FIG. 7 is a diagram illustrating an example of a tray editing screen;

FIG. 8 is a diagram illustrating another example of the tray editing screen;

FIG. 9 is a diagram illustrating still another example of a tray editing screen;

FIG. 10 is a diagram illustrating a tray file output instruction on the workflow design screen;

FIG. 11 is a diagram illustrating a former half of a processing procedure of the application when an instruction to import the tray is made;

FIG. 12 is a diagram illustrating a latter half of the processing procedure of the application when the instruction to import the tray is made;

FIG. 13 is a diagram illustrating an example of a flow screen and an import confirmation dialog displayed by an import-side application;

FIG. 14 is a diagram illustrating another example of the import confirmation dialog displayed by the import-side application;

FIG. 15 is a diagram illustrating still another example of the import confirmation dialog displayed by the import-side application;

FIG. 16 is a diagram illustrating another example of the processing procedure of the application when the instruction to edit the tray is made; and

FIG. 17 is a diagram illustrating a main portion of a processing procedure of the application when a tray file includes a condition of a link destination.

### DETAILED DESCRIPTION

Transfer System of Data Using Tray

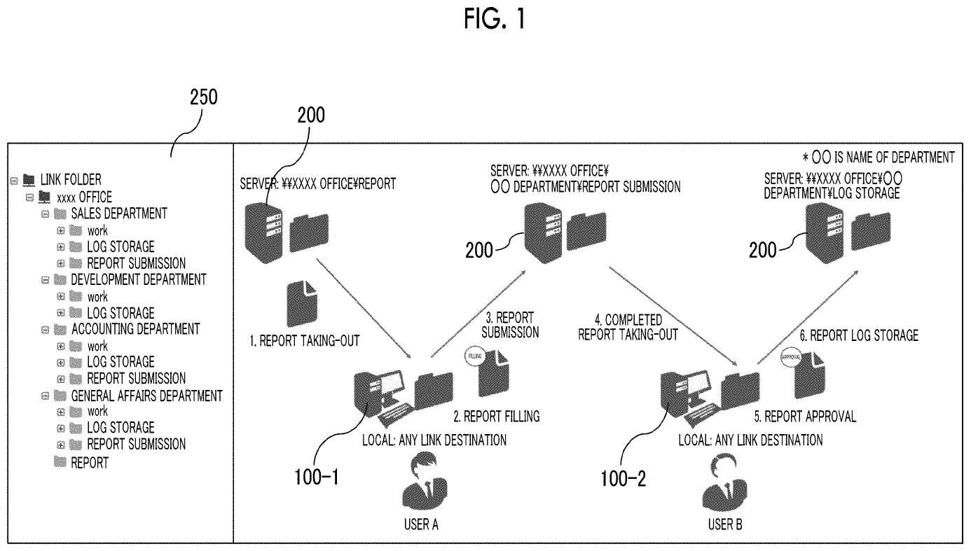

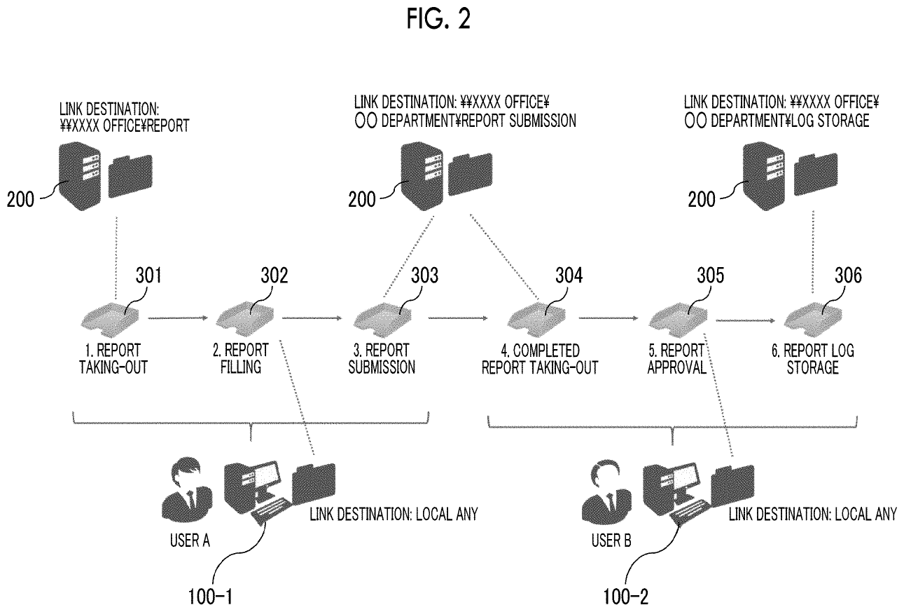

A system of transferring data with representation information representing a storage area will be described with reference to FIGS. 1 and 2.

FIG. 1 illustrates a workflow realized by two users A and B through a server 200. In the example, the server 200 is, for example, a file server of “XXXX office” and has a folder tree represented by a folder tree image 250. The folder tree includes folders for departments, such as “sales department”, “development department”, “accounting department”, and “general affairs department” and a “report” folder. The folder for each department hierarchically includes a group of lower folders.

The users A and B realize a workflow by transferring data through a specific folder in the server 200 from personal computers (PCs) 100-1 and the 100-2 of the users A and B. In the workflow illustrated in FIG. 1, the user A downloads a report template from a folder “YYXXXX officeYreport” in the server 200 to the PC 100-1 of the user A. The user A fills in the report on the PC 100-1 and uploads the completed folder to a folder “YYXXXX officeOO departmentYreport submission” in the server 200. “00 department” in the path of the folder refers to a department to which the users A and B belong among the sales department, the development department, the accounting department, and the general affairs department. The user B downloads the completed report to the PC 100-2 of the user B from the folder “YYXXXX officeYOO departmentYreport submission” in the server 200. The user B approves the completed report on the PC100-2 and uploads the approved report to a folder “YYXXXX officeYOO departmentYlog storage” in the server 200.

A mechanism realizing the workflow in FIG. 1 using “tray” will be described with reference to FIG. 2. Trays 301 to 306 represent folders as an example of storage locations of data. In other words, the trays 301 to 306 are folder metaphors. The trays 301 to 306 are displayed on the screens of the PCs 100-1 and 100-2 of the users A and B, for example, in a form of icons representing paper tray illustrated in FIG. 2.

Among the trays, the trays 301 to 303 are displayed on the screen of the PC 100-1 of the user A. The tray 301 is named “1. Report Taking-out” and is linked to the folder “YYXXXX officeYreport” in the server 200. The tray 302 is named “2. Report Filling” and is linked to a folder in the PC 100-1, which is prepared for the user A preserving a file of the report as a filling target. The tray 303 is named “3. Report Taking-out” and is linked to the folder “YYXXXX officeYOO departmentYreport submission” in the server 200. The name of each of the trays 301 to 303, information of a link destination, information of an icon image and the like are held in the PC100-1 as information for defining the trays 301 to 303. As described above, the information for defining the trays 301 to 303 refers to representation information representing the folder (that is, storage area” as a link destination of each of the trays 301 to 303.

The user A performs an operation (for example, double-clicking) of opening the tray 301 on the screen to open the folder “YYXXXX officeYreport” in the server 200. The user A drags and drops the icon of a report in the folder displayed on the screen in accordance with the operation to the tray 302 on the screen, so as to download a template file of the report to a folder in the PC 100-1. Then, the user A opens the tray 302, opens the template of the report in the tray 302, and performs an operation of filling desirable items in the template. In a case where the filling is completed, the user A drags and drops the icon of the completed report to the tray 303, so as to upload the report to the folder “YYXXXX officeYOO departmentYreport submission” in the server 200.

The trays 304 to 306 are displayed on the screen of the PC 100-2 of the user B. The tray 304 is named “4. Completed Report Taking-out” and is linked to the folder “YYXXXX officeYOO departmentYreport submission” in the server 200. The tray 305 is named “5. Report Approval” and is linked to a folder in the PC 100-2, which is prepared for the user B preserving a file of the report as an approval target. The tray 306 is named “6. Report Log Storage” and is linked to the folder “YYXXXX officeYOO departmentYlog storage” in the server 200.

The user B performs an operation of opening the tray 304 on the screen, and thus opens the folder “YYXXXX officeYreport submission” in the server 200 and drags and drops the icon of the completed report in the folder to the tray 305 on the screen. Then, the user B opens the completed report in the tray 305 and checks the contents. Then, in a case where approving the report is possible, the user B performs an approval operation (for example, operation of adding an approval seal object of the user B to the completed report). The user B drags and drops the icon of the approved report to the tray 306, so as to upload the report to the folder “YYXXXX officeYOO departmentYlog storage” in the server 200.

In the example in FIGS. 1 and 2, the folders as the link destinations of the trays 301 to 306 constituting the workflow are in the server 200 (or in the PC of the user). However, the link destinations of the trays constituting the workflow may be in servers, respectively.

The functions of the trays 301 to 306 as described above are realized by a tray service application installed on each of the PCs 100-1 and 100-2. That is, in a case where an opening operation or a file drop operation is performed on the trays 301 to 306, the application associated with the trays 301 to 306 operates. The application opens the folders as the link destinations of the trays 301 to 306 or stores a file in the folder as the link destination.

The trays 301 to 306 are displayed on desktop screens of the PCs 100-1 and 100-2 or windows provided by the application, for example.

Example of Hardware Configuration of PC

Here, a hardware configuration of the PCs 100-1 and 100-2 that execute the application will be described.

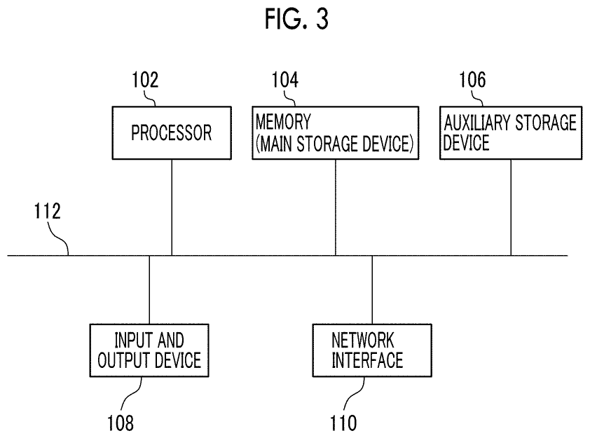

The PCs 100-1 and 100-2 are one type of computer. For example, as illustrated in FIG. 3, as hardware, the PCs 100-1 and 100-2 have a circuit configuration in which a processor 102, a controller that controls a memory (main storage device) 104 such as a random access memory (RAM), an auxiliary storage device 106 such as a flash memory, a solid state drive (SSD), and a hard disk drive (HDD), an interface with various input and output devices 108, a network interface 110 that performs a control for a connection with a network such as a local area network, and the like are connected to each other via a data transmission path such as a bus 112, for example. The above-described tray service application is installed on the computer via the network or the like and is preserved in the auxiliary storage device 106. The functions of the application are realized by the processor 102 executing the application preserved in the auxiliary storage device 106 with the memory 104.

Here, in the exemplary embodiments above, the processor 102 refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

The term “processor” 102 is broad enough to encompass one processor 102 or plural processors 102 in collaboration which are located physically apart from each other but may work cooperatively. The order of operations of the processor 102 is not limited to one described in the exemplary embodiments below, and may be changed.

Other devices such as the server 200 are also configured based on a computer, similar to the PCs 100-1 and 100-2.

Edit of Workflow and Tray

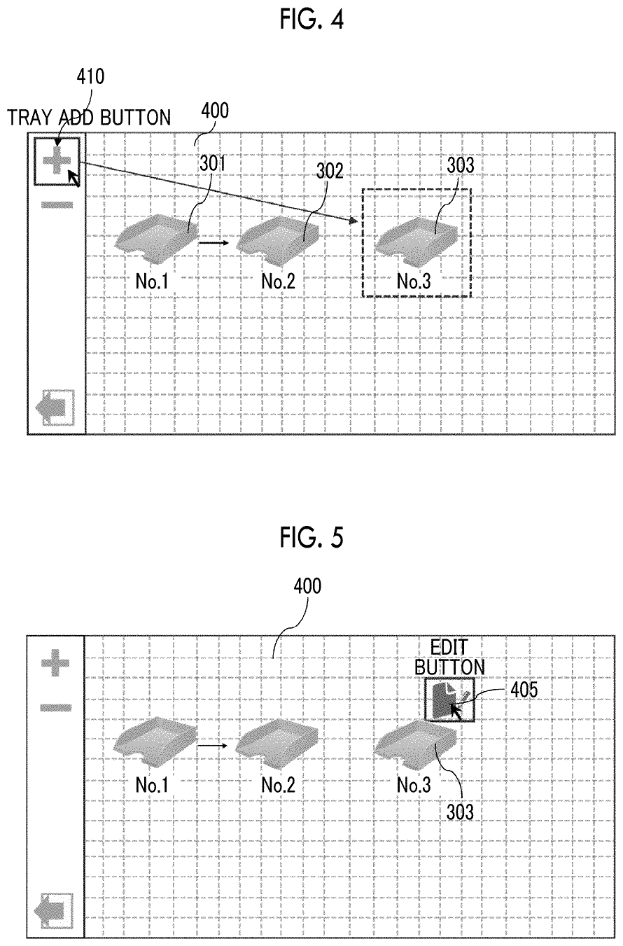

In the tray service application (simply referred to as “the application” below), for example, a workflow design screen 400 illustrated in FIG. 4 is provided as a user interface (UI) for designing a workflow using a tray. A user (referred to as a flow designer below) who wants to design a workflow starts the application installed on the PC of the user and selects a workflow design from a menu (not illustrated) provided by the application. Thus, the application displays the workflow design screen 400 on the screen of the PC.

The workflow design screen 400 illustrated in FIG. 4 shows a screen state at a time point at which a flow including two trays 301 and 302 of “No. 1” and “No. 2” is designed already, and then the flow designer presses a tray add button 410 to add a new tray 303 to the flow. The application displays an icon of the tray 303 named “No. 3” by automatic numbering, in a free region in the workflow design screen 400 in response to pressing of the tray add button 410. At this time point, the link destination and other pieces of necessary information are not set in the tray 303.

Thus, as illustrated in FIG. 5, the flow designer calls an edit button 405 of the tray 303 and presses the edit button 405, and thus edits information (referred to as setting information of the tray 303 below) for defining the tray 303. With the edit, the name or the link destination of the tray 303, a tray before or after the tray 303 in the workflow, and the like are set.

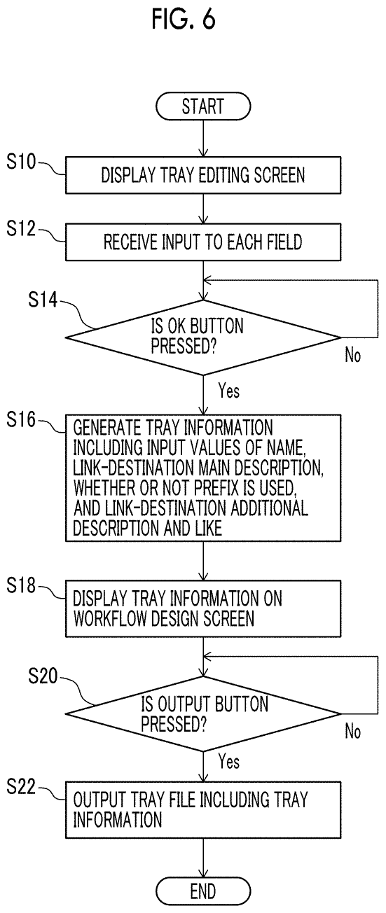

FIG. 6 illustrates a processing procedure executed by the processor 102 executing the application, when the edit button 405 is pressed.

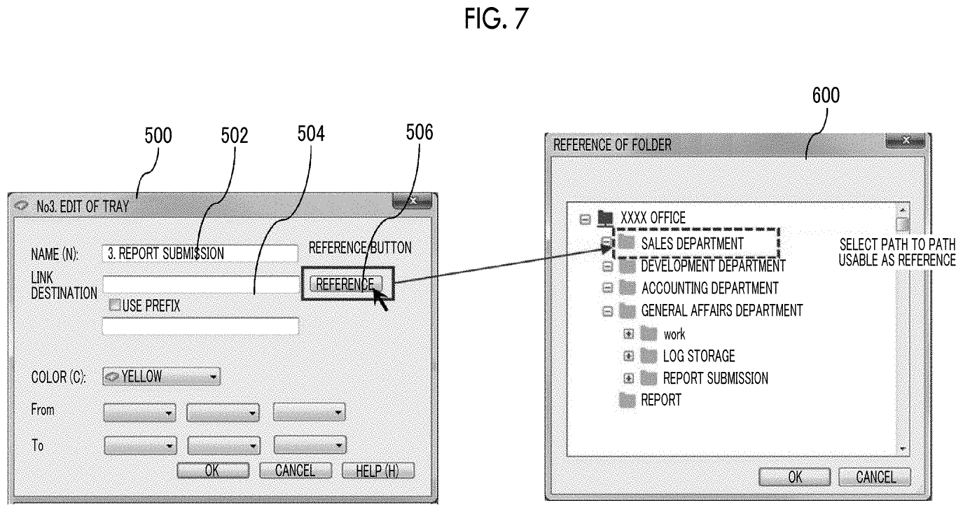

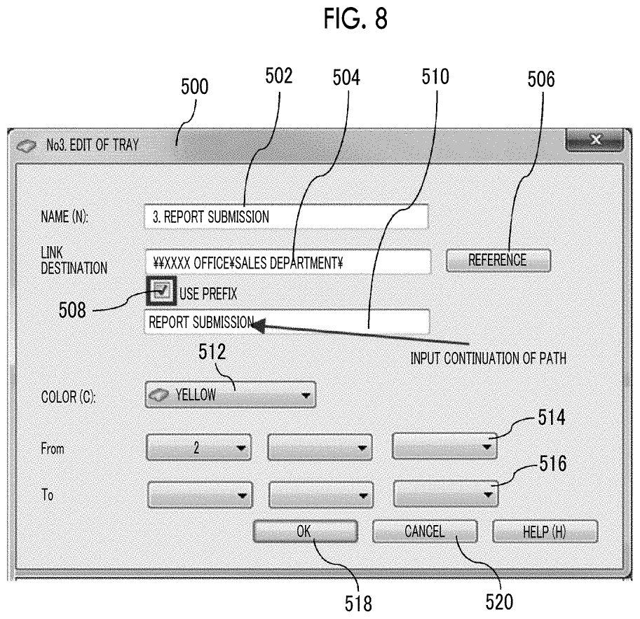

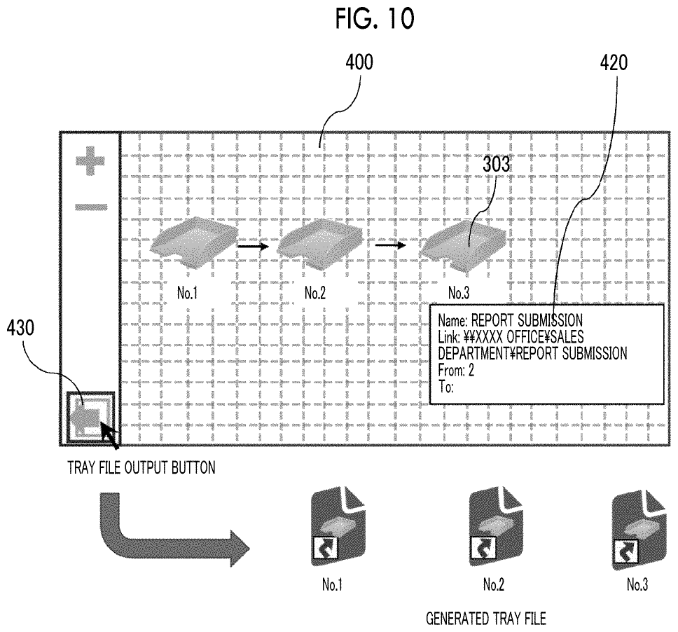

In the procedure, firstly, the processor 102 displays a tray editing screen 500 (see FIGS. 7 and 8) (S10). The tray editing screen 500 will be described later with reference to FIGS. 7 and 8. Then, the processor 102 receives an input from the flow designer for each input field in the tray editing screen 500 (S12). In a case where the flow designer presses an OK button 518 (see FIG. 8) indicating completion of editing (Yes in S14), the processor 102 generates tray information including information input to the input fields (S16). The processor 102 closes the tray editing screen and displays the workflow design screen 400. Contents of the tray information are displayed in the vicinity of the icon of the tray 303 in the workflow design screen 400 (S18). In a case where the flow designer ends editing of the workflow and all trays constituting the workflow, the flow designer presses a tray file output button 430 (see FIG. 10) in the workflow design screen 400. In a case where the pressing is detected (determination result in S20 is Yes), the processor 102 outputs a tray file including tray information of each of the trays 301, 302, and 303 displayed on the workflow design screen 400 (S22).

The flow designer provides the obtained tray file for the workflow for a user who uses the tray file. For example, in the example of the workflow in FIG. 2, the flow designer provides a tray file group of the trays 301 to 303 for the user A, and provides a tray file group of the trays 304 to 306 for the user B.

The edit of the tray will be described in more detail with reference to specific examples illustrated in FIGS. 7 to 10.

FIGS. 7 and 8 are diagrams illustrating an example of the tray editing screen 500. A case where the tray 303 is set as an edit target will be described below as an example. Some input fields such as a name input field 502 and a link destination input field are displayed on the tray editing screen 500. The name input field 502 is a field for receiving an input of the name of the tray 303 as the edit target. The flow designer inputs a text string indicating a name desired to be attached to the tray 303 to the name input field 502.

The link destination input field is a field for inputting information of a path or the like for specifying a folder as a link destination of the tray 303 as the edit target. The path of the folder as the link destination refers to information indicating a location at which a folder being a storage area corresponding to the tray 303 is provided, that is, indicating a position on the folder tree. As illustrated in FIG. 8, the link destination input field includes a link-destination main input field 504, a reference button 506, a checkbox 508 for inputting whether or not a prefix is used, and a link-destination additional input field 510.

A path for specifying the folder as the link destination of the tray 303 or at least a prefix portion in the path is input to the link-destination main input field 504.

Regarding the input of the path to the link-destination main input field 504, a text input from a keyboard is also possible. However, the input may be performed with a folder tree screen 600 called by pressing the reference button 506. The folder tree screen 600 is a graphical user interface (GUI) screen showing a tree structure of a folder group accessible from the PC. The folder tree screen 600 is provided from an operating system of the PC. The tree structure of the folder to which the user who operates the PC has an access authority is displayed on the folder tree screen 600 illustrated in FIG. 7. In the example, it is assumed that the flow designer who designs the workflow is a member of the general affairs department. In this case, folders lower than “the general affairs department” folder in the “XXXX office” folder are displayed on the folder tree screen 600 provided for the flow designer. However, since the flow designer does not have an access authority to the other departments in the same office, that is, the folder group of “the sales department”, “the development department”, or “the accounting department”, only the folder on the top in each department is displayed on the folder tree screen 600. In a case where the flow designer selects an icon of a folder in the folder tree screen 600 with a click operation or the like and presses an OK button on the identical screen, the application inputs a text string indicating the path of the folder to the link-destination main input field 504.

Here, it is assumed that the flow designer (that is, member of the general affairs department) is designing a workflow of report processing for a member (referred to as “a sales member” below) of the sales department. In this workflow, it is assumed that it is planned to use a folder “YYXXXX officeYsales departmentYreport submission” being a lower folder of the “sales department” folder, for transferring a report file between sales members. In this case, since the flow designer does not have an access authority to the folder “YYXXXX officeYsales departmentYreport submission”, it is not possible to select the folder on the tree structure displayed on the folder tree screen 600.

In this case, the flow designer selects “the sales department” folder being a limit in which the flow designer is allowed to refer to, on the folder tree screen 600. Thus, a path description “YYXXXX officeYsales departmentY” from a root “YYXXXX officeY” of the tree to the selected “sales department” folder is input to the link-destination main input field 504 (see FIG. 8). The flow designer inputs a check mark to the checkbox 508 in order to designate a folder “report submission” being a lower folder of “the sales department” folder. Thus, the path description input to the link-destination main input field 504 is used as a prefix (forward portion) of the path for the folder as the link destination of the tray 303 in the process of being edited, and thus the backward portion of the path may be input to the link-destination additional input field 510. In the example in FIG. 8, the flow designer has the prior knowledge that “the report submission” folder is provided in “the sales department” folder, and wants to set the “report submission” folder as the link destination of the tray 303, a text string of “report submission” is input to the link-destination additional input field 510. Thus, the folder “YYXXXX officeYsales departmentYreport submission” is set as the link destination in the tray 303.

As illustrated in FIG. 8, a color selection field 512 for selecting a display color (referred to as “a tray color) of the tray 303 as the edit target is displayed as another input field on the tray editing screen 500. Selectable colors are displayed in the color selection field 512 in a pull-down menu. The flow designer selects a desired color from the menu.

A selection field 514 for selecting a tray (“From” in FIG. 8) on the workflow just before the tray 303 as the edit target and a selection field 516 for selecting a tray (“To”) just after the tray 303 as the edit target are displayed, as still another input fields, on the tray editing screen 500. In the example illustrated in FIG. 8 in which tray numbers selected in the selection fields 514 and 516 are respectively referred to as “the previous tray” and “the following tray”, three selection fields 514 and three selection field 516 for the previous tray and the following tray are displayed, and this indicates that the three previous trays and the three following trays of the tray 303 in maximum may be selected. A pull-down menu for showing a tray number group is displayed in the selection fields 514 and 516, and the flow designer selects the tray number from the pull-down menu. The tray number is, for example, a consecutive number that has already been added to the workflow design screen 400 and is assigned to each tray to be added in the order of addition. Instead, the names of the trays 301 and 302 added to the workflow design screen 400 may be displayed in the pull-down menu of the selection fields 514 and 516.

The OK button 518 and a cancel button 520 are displayed at a lower end of the tray editing screen 500. The OK button 518 is a button for an instruction to employ the content input to the tray editing screen 500. In a case where the OK button 518 is pressed, the processor 102 generates tray information configured by a set of values input to the input fields in the tray editing screen 500 and then closes the tray editing screen 500 (S14 and S16 in FIG. 6). The cancel button 520 is a button for an instruction not to employ the content input to the tray editing screen 500. In a case where the cancel button 520 is pressed, the processor 102 discards information input to the input fields in the tray editing screen 500 and then closes the tray editing screen 500.

The tray information generated by the processor 102 in S16 includes an ID (identification information) of the workflow in the middle of being designed on the workflow design screen 400, a number indicating the order of the tray in the workflow, and a text string of the name input to the name input field 502. The tray information includes a value of the path (referred to as “a link-destination main description”) input to the link-destination main input field 504, a value indicating whether or not a check mark is assigned to the checkbox 508 (referred to as “presence or absence of the prefix”), the subsequent portion (referred to as “a link-destination additional description”) of the path, which is input to the link-destination additional input field 510, a value of the tray color, and values of the previous tray and the following tray.

In a case where the value of the checkbox 508 (that is, “presence or absence of the prefix) is “none”, the link destination is completely expressed by the path description in the link-destination main input field 504. Thus, the input value in the link-destination additional input field 510 is not provided, and the value for a prefix additional description in the tray information is empty. In a case where the value of the checkbox 508 is “provided”, inputting the subsequent portion of the path to the link-destination additional input field 510 is possible, and the text string input to this field is the value of the link-destination additional description. In the example in FIG. 8, the flow designer inputs a text string representing the subsequent portion of the path to the link-destination additional input field 510. The input to the link-destination additional input field 510 is not necessary. For example, a user (referred to as “an import-side user” below) who is to import and use the tray 303 may be caused to designate the subsequent portion following the main description of a link. In this case, the value of the checkbox 508 is “check mark provided”, and the input value in the link-destination additional input field 510 is empty.

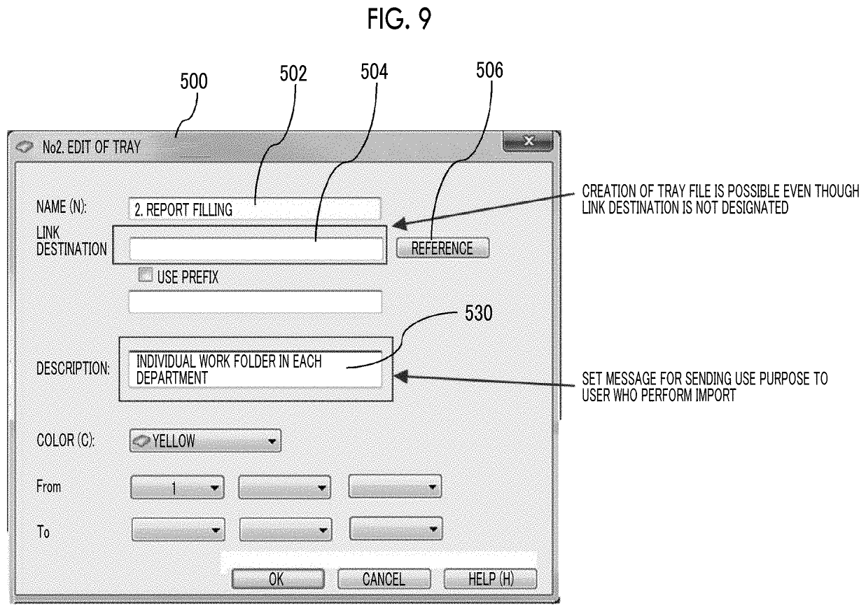

A tray having a blank link-destination main input field 504 may be created. This corresponds to a case where the import-side user is caused to designate the entirety of the path of the link destination of the tray. Another example of the tray editing screen 500 illustrated in FIG. 9 includes a description field 530 to which a description showing which folder is to be selected as the link destination of the tray by the import-side user is input. In the example in FIG. 9, the screen for editing the tray 302 having a link destination set to be a local folder in the PC 100-1 in the workflow example in FIG. 2 is illustrated. In this case, the flow designer does not know the local folder structure of the user A. Thus, it is not possible to input the path to the link-destination main input field 504. The user A on the import side may freely determine the link destination of the tray 302, and thus the link-destination main input field 504 to be designated by the user A is set to be blank. The flow designer inputs a description indicating which folder is to be selected as the link destination of the tray 302, to the description field 530. Information of the description is incorporated in tray information as an edit result. The information of the description is an example of condition information designated by the flow designer for the link destination to be input later by the import-side user.

In the example in FIG. 9, the link-destination main input field 504 is blank. Therefore, the value of the checkbox 508 indicating whether or not the prefix is used automatically has “no check mark”, and the link-destination additional input field 510 is in a state where an input is not possible (that is, the value is empty). In this case, the link-destination main description in the tray information is null, the presence or absence of the prefix is “none”, and the link-destination additional description is null.

As another example for this, the flow designer may input a path to the link-destination main input field 504, put a check mark into the checkbox 508, and create a tray having an empty link-destination additional input field 510. In this case, the path description input to the link-destination main input field 504 functions as a path prefix, and the import-side user designates the remaining portion of the path, which follows the path prefix. In order to assist the designation, the flow designer may input a description for specifying a folder to be selected by the import-side user, to the description field 530. In this example, the link-destination main description in the tray information is a text string input by the flow designer, the presence or absence of the prefix is “provided”, and the link-destination additional description is null.

In a case where the prefix is used in the path of the link destination of the tray 303, the path is obtained by adding a path description of the subsequent portion, which is input to the link-destination additional input field 510, after the path description of the prefix, which is input to the link-destination main input field 504. The flow designer inputs only a path of an accessible folder to the link-destination main input field 504. Thus, in a case where the flow designer designates a folder to which an access is not possible, to be the link destination, the link-destination additional input field 510 is used. As described above, the flow designer partially designates the path of an accessible folder as the link destination of the tray.

Here, a text string indicating a folder which does not exist at an input time point may be input to the link-destination additional input field 510. The application does not check the access authority of the flow designer for the path description input to the link-destination additional input field 510 and does not check whether the folder indicated by the path description is provided. In a case where the path of the link destination, which is obtained by merging the path description in the link-destination main input field 504 and the path description in the link-destination additional input field 510 indicates a folder which does not exist, the import-side user creates folder later.

In a case where the tray 303 is edited as the input content of the tray editing screen 500 illustrated in FIG. 8, and then the OK button 518 is pressed, the workflow design screen 400 displayed in the PC of the flow designer is in a state illustrated in FIG. 10. In the example in FIG. 10, an information display field 420 of the tray 303 is displayed in the vicinity of the tray 303 of which the edit is currently completed. The name (text string on the left side of an item “Name” in FIG. 10) of the tray 303, the path of the link destination (text string on the left side of an item “Link” in FIG. 10), the previous tray number (number “2” shown on the left side of an item “From” in FIG. 10), and the rear tray number (on the left side of an item “To” in FIG. 10. In this example, none) are displayed in the information display field 420. The context or the order in the workflow of the tray in the middle of being edited is understood by the previous tray number and the following tray number. The flow designer checks the setting information of the edited trays 301, 302, and 303. In a case where the setting information is appropriate, the flow designer presses the tray file output button 430. In response to the pressing, the processor 102 outputs the tray information of the trays 301, 302, and 303 displayed in the workflow design screen 400, in a form of a file (that is, tray file). The tray file to be output includes information (for example, extension indicating that the file is a tray file) indicating that the file is a tray file.

The tray file includes values of items such as information indicating that the file is a tray file, a workflow ID, a number indicating the order of the tray in the workflow, a link-destination main description, the presence or absence of the prefix, a link-destination additional description, a description, a tray color, the previous tray, and the following tray.

The flow designer provides the output tray file for the import-side user using the tray file.

Import of Tray File

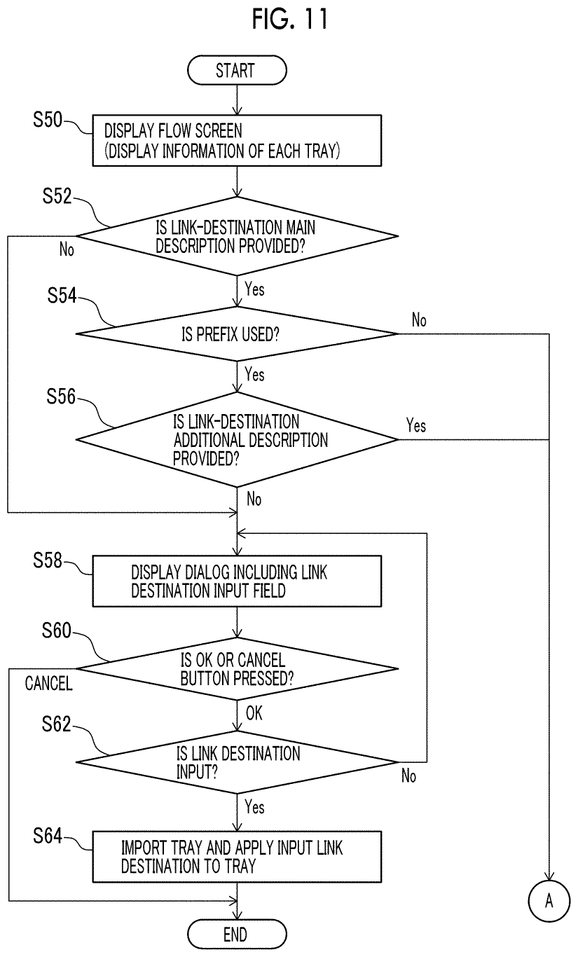

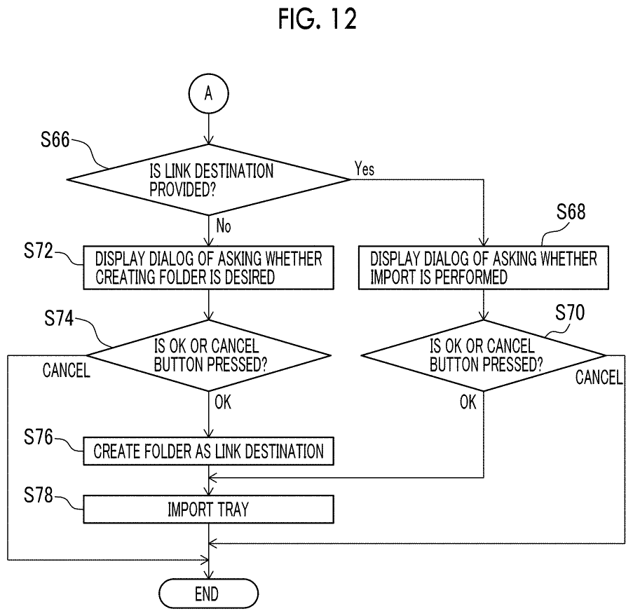

Next, a procedure of import processing of the tray in the PC of the import-side user who receives the tray file created by the flow designer will be described with reference to FIGS. 11 and 12.

In a case where a tray file is opened by a double-clicking operation or the like on the PC, the application starts, and the procedure of import processing illustrated in FIGS. 11 and 12 is performed.

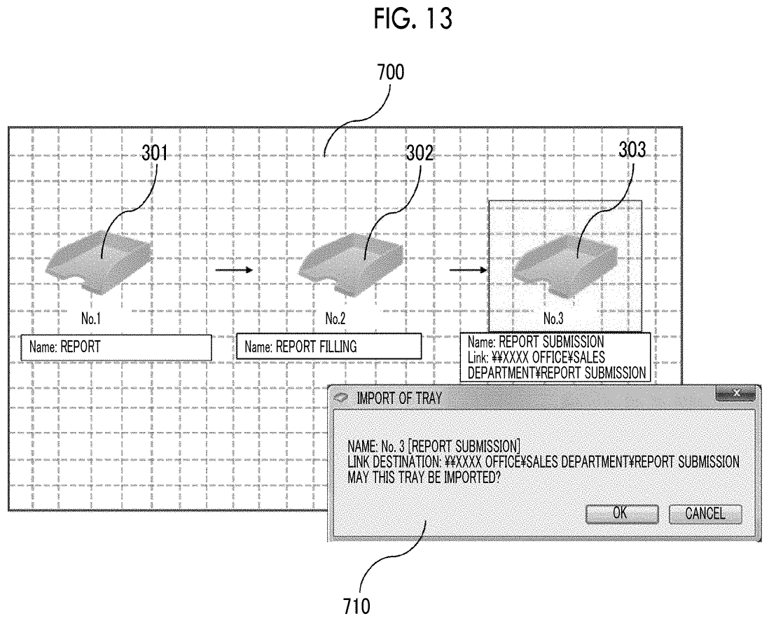

In the procedure, the processor 102 of the PC executing the application displays a flow screen 700 showing a workflow including a tray indicated by the opened tray file (S50). For example, FIG. 13 illustrates the flow screen 700 displayed when the tray file of the tray 303 edited as in the example in FIG. 8 is opened. In the example in FIG. 13, it is assumed that the trays 301 and 302 in the identical workflow are imported already. The imported trays 301 and 302 and the tray 303 as an import target are displayed on the flow screen 700 along with arrows indicating the order in the workflow. The number indicating the order of the tray may be displayed in the vicinity of each of the trays 301 to 303 on the flow screen 700. In a case where the flow screen 700 is displayed, the processor 102 may examine a workflow ID set in each imported tray in the PC, and thus identify a tray belonging to a workflow identical to a workflow for the tray as the import target.

Then, the processor 102 determines whether or not a text string of the link-destination main description is provided in the tray file as the import target (S52). In a case where the determination result is No, no description of the path of the link destination is included in the tray file. In this case, the processor 102 displays an import confirmation dialog including the link destination input field on the flow screen 700 (S58).

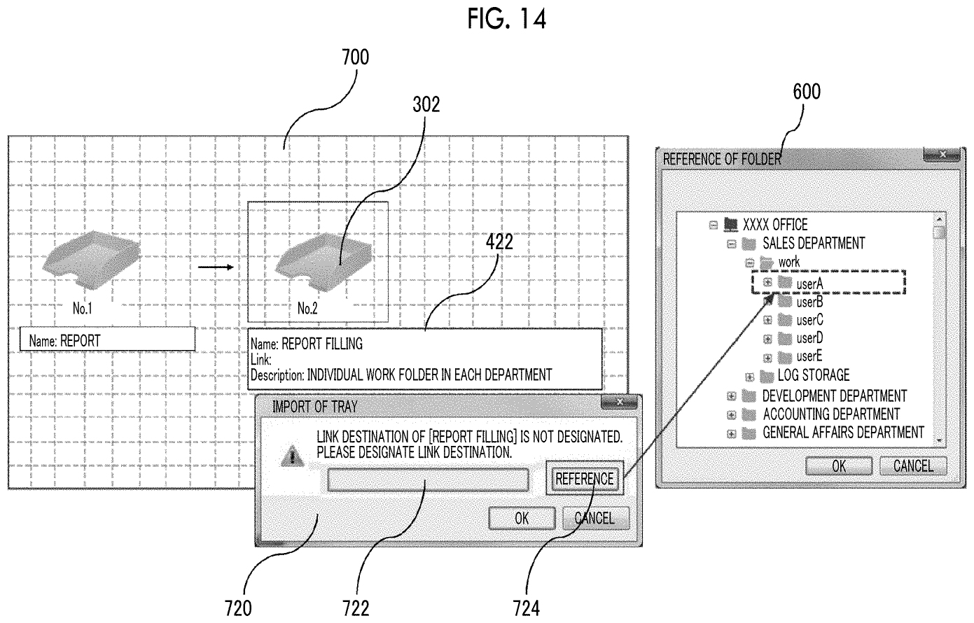

FIG. 14 illustrates an import confirmation dialog 720 including a link destination input field 722. The example illustrates the flow screen 700 displayed when the tray file of the tray 302 edited as in the example in FIG. 9 is opened and the import confirmation dialog 720 displayed on this screen in a pop-up manner. In the information display field 422 of the tray 302 in the flow screen 700, the name referred to as “report filling” is displayed in a name field (“Name” in FIG. 14), and a link destination field (“Link” in FIG. 14) is empty. A description referred to as “an individual work folder in each department” is shown in the description field (“Description” in FIG. 14). The link destination input field 722 is displayed in the import confirmation dialog 720 along with a message for urging a user to designate a link because the link is not designated. In a case where a reference button 724 displayed adjacent to the link destination input field 722 is pressed, the folder tree screen 600 showing an accessible folder tree from the PC is displayed. In a case where the user views and selects a folder corresponding to the description of “the individual work folder in each department” on the folder tree screen 600, the path “YYXXXX officeYsales departmentYworkYuserAY” of the folder is set in the link destination input field 722. Then, in a case where the user presses an OK button in the import confirmation dialog 720, the path of the input link destination is set in the tray 302, and thus the desired information is completely set in the tray 302. Thus, the tray 302 is imported to the PC, and the icon of the tray 302 is displayed on a specific screen (for example, desktop screen).

Returning to the description for FIG. 11, the processor 102 displays the import confirmation dialog 720 in S58, and then waits for pressing the OK button or a cancel button in the dialog (S60). In a case where the OK button is pressed, the processor determines whether or not a valid path (that is, path in the PC or the network) is input to the link destination input field 722 (S62). In a case where the determination result is No, the process returns to S58, and the import confirmation dialog 720 is displayed again. In a case where the determination result of S62 is Yes, the processor 102 imports the tray in which the tray information in the tray file and the path of the link destination input to the link destination input field 722 are set, to the PC (S64). Then, the import processing is ended.

In a case where the cancel button is pressed in S60, the processor 102 does not import the tray and ends the import processing.

In a case where the determination result of S52 is Yes, the processor 102 determines whether or not the value of the presence or absence of the prefix in the tray file is “provided” (S54). In a case where the determination result of S54 is Yes, the processor further determines whether or not the text string of the path is included in the item of the link-destination additional description in the tray file (S56).

In a case where the determination result of S56 is No, that is, in a case where the value of the link-destination additional description is empty, the processor 102 displays the import confirmation dialog 720 including the link destination input field 722 (S58). Differing from the example in FIG. 14, the text string (that is, the prefix of the path) of the link-destination main description in the tray file has been input to the link destination input field 722 at this time. Then, the user inputs the remaining portions. Although illustrations are omitted, a lower folder group of the folder indicated by the prefix is displayed on the folder tree screen 600 opening in a case where the user presses the reference button 724. Thus, the user easily selects the folder as the link destination. As described above, the link destination of the tray file may be determined in a manner that, in a case where the tray file is imported, the import-side user partially designates an accessible location. Then, the processes of S60 to S64 described already are performed.

In a case where the determination result of S54 is No (that is, the presence or absence of the prefix is “none”), or the determination result of S56 is Yes (that is, the link-destination additional description is not null), the processor 102 proceeds to the procedure in FIG. 12.

In the procedure in FIG. 12, the processor 102 determines whether or not the folder as the link destination of the tray, which is indicated by information in the tray file is provided (S66). In a case where the determination result of S54 is No (that is, the prefix is not used), the link destination as a determination target is a path indicated by the link-destination main description. In a case where the determination result of S56 is Yes (in this case, the prefix is used), in S66, the processor determines whether or not the path obtained by merging the link-destination additional description after the link-destination main description indicates the existing folder.

In a case where the determination result of S66 is Yes, as illustrated in FIG. 13, the processor 102 displays an import confirmation dialog 710 for simply asking whether or not the tray is imported, in a pop-up manner (S68). The name and the link destination of the tray included in the tray file are displayed in the import confirmation dialog 710, and a message for asking that the tray having the name and the link destination may be imported is displayed. The processor 102 waits for pressing the OK button or the cancel button in the import confirmation dialog 710. In a case where the OK button is pressed, the processor 102 imports the tray in which tray information included in the tray file is set, to the PC (S78). Then, the import processing is ended. In a case where the cancel button is pressed, the processor 102 does not import the tray and ends the import processing.

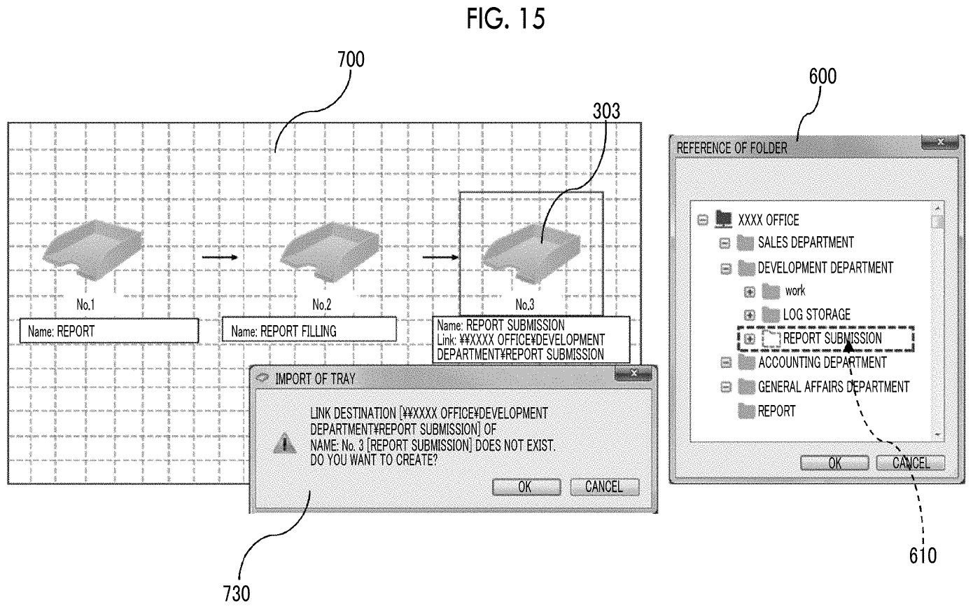

In a case where the determination result in S66 is No, the folder as the link destination, which is indicated by the tray file does not exist. In this case, as illustrated in FIG. 15, the processor 102 displays an import confirmation dialog 730 for asking whether or not the folder is created, in a pop-up manner (S72). The name and the link destination of the tray included in the tray file are displayed in the import confirmation dialog 730, and a message indicating that the link destination does not exist and a message for asking whether the link destination is created are displayed. The processor 102 displays the folder tree screen 600 showing a position 610 in the folder tree of the non-existing folder being a target of the asking. The user checks the displays, determines whether or not the folder as the link destination is created, and presses the OK button or the cancel button in the import confirmation dialog 730 in accordance with the determination. In a case where the OK button is pressed, the processor 102 performs processing of creating the folder as the link destination (S76), and imports the tray in which the tray information included in the tray file is set, to the PC (S78). Then, the import processing is ended. In a case where the cancel button is pressed, the processor 102 does not perform the processes of S76 and S78 and ends the import processing.

In the procedures in FIGS. 11 and 12 described above, in a case where the determination result of S52 or S56 is No, the import-side user is caused to designate the path of the link destination (S58). In other cases, the user is not caused to designate the link destination. That is, a point that the link-destination main description in the tray file is null (No in S52) or a point that the presence or absence of the prefix is “provided”, and the link-destination additional description is null (No in S56) function as designation information implicitly indicating that the import-side user is caused to designate the link destination. In other words, in a case where the flow designer makes an instruction to create the tray file in a state where the link-destination main description is null, the instruction implicitly indicates that the import-side user is caused to designate the link destination. Similarly, in a case where the flow designer inputs the link-destination main description, puts a check mark into the checkbox 508 for the presence or absence of the prefix, but makes an instruction to create the tray file in a state where the link-destination additional description is null, the instruction implicitly indicates that the import-side user is caused to designate the link destination. Reversely, in a case where the flow designer inputs the link-destination main description, puts a check mark into the checkbox 508 for the presence or absence of the prefix, and inputs the link-destination additional description to make an instruction to create the tray file, the instruction implicitly indicates that the import-side user is not caused to designate the link destination. Similarly, in a case where the flow designer inputs the link-destination main description, does not put a check mark into the checkbox 508 for the presence or absence of the prefix, and makes an instruction to create the tray file, the instruction implicitly indicates that the import-side user is not caused to designate the link destination.

As described above, in the above-described example, the processor 102 in a case where the tray file is created desires some inputs for implicitly presenting whether or not the import-side user is caused to designate the folder as the link destination of the tray. The tray information indicating the input contents is an example of representation information representing the tray. The tray file including the tray information is provided for the import-side user from the flow designer. In a case where the tray file is imported to the PC of the import-side user, the tray in which the tray information including the tray file is set is imported to the PC. At this time, in a case where an instruction content for implicitly desiring designation of the folder as the link destination is included in the tray information, the PC causes the import-side user to designate the folder as the link destination and reflects the content of the designation to the tray to be imported.

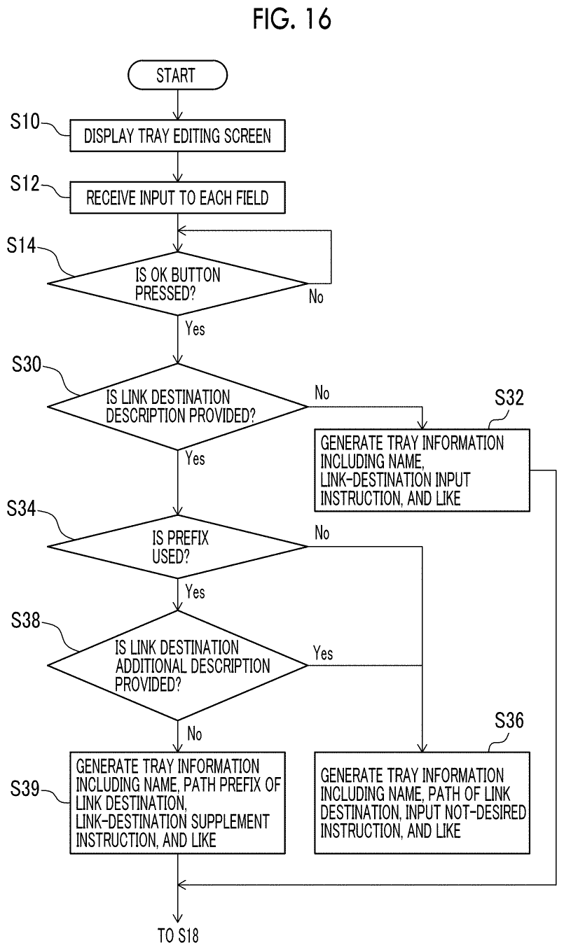

The above-described example is an example in which tray information including an instruction of whether or not the import-side user is caused to designate the link destination of the tray, as an implicit instruction is generated. However, instead of this example, the tray information including the instruction as explicit designation information may be generated. FIG. 16 illustrates a processing procedure performed by the processor 102 of the PC of the flow designer in this case. In the procedure in FIG. 16, steps similar to those in the procedure in FIG. 6 are denoted by the identical reference signs.

Generally, in the procedure in FIG. 16, determination similar to S52 to S54 in the procedure in FIG. 11 is performed on an input content input to the tray editing screen 500 by the flow designer, and explicit designation information corresponding to the determination result is incorporated in the tray information, and the tray file.

More specifically, in the procedure in FIG. 16, in a case where the user performs an input to the tray editing screen 500, and presses the OK button on the identical screen (determination result in S14 is Yes), the processor 102 determines whether or not the input content includes the text string of the link-destination main description (S30). In a case where the determination result is No, the processor 102 generates tray information including the name of the tray and a link destination input instruction, and information of a tray color and the like (S32). The link destination input instruction is explicit designation information for causing the import-side user to designate the folder as the link destination.

In a case where the determination result of S30 is Yes, the processor 102 determines whether or not the checkbox 508 for whether or not the prefix is used is “check mark provided” (S34). In a case where the determination result of S34 is No, the processor 102 generates tray information including the name of the tray, the path of the link destination indicated by the link-destination main description, a link-destination input not-desired instruction, and information of the tray color or the like (S36). The link-destination input not-desired instruction is explicit designation information indicating that the import-side user is not caused to designate the folder as the link destination.

In a case where the determination result of S34 is Yes, the processor 102 determines whether or not a text string is input to the link-destination additional input field 510 (S38). In a case where the determination result of S38 is Yes, the processor 102 generates tray information including the name of the tray, the path of the link destination obtained by merging the link-destination main description and the link-destination additional description, the link-destination input not-desired instruction, and information of the tray color or the like (S36).

In a case where the determination result of S38 is No, the processor 102 generates tray information including the name of the tray, the link-destination main description, a link-destination supplement instruction, and information of the tray color or the like (S39). The link-destination supplement instruction is explicit designation information for causing the import-side user to supplement the path description after the link-destination main description, that is, in this case, the path prefix.

After S32 and S36 or S38, the processor 102 performs the procedure after S18 illustrated in FIG. 6 and outputs the tray file including tray information.

In the PC on a side on which the tray file generated in accordance with the procedure in FIG. 16 is imported, the processor 102 performs processing as follows. That is, in a case where the tray file includes the link-destination input not-desired instruction, the processor 102 performs processing similar to that in a case where the determination result of S54 is No, or the determination result of S56 is Yes, in the procedure of FIGS. 11 and 12. In a case where the tray file includes the link destination input instruction, the processor 102 performs processing after S58 in the procedure of FIG. 11. In this case, the processor 102 displays the import confirmation dialog 720 in which the link destination input field 722 is empty, and receives an input of the link destination. In a case where the tray file includes the link-destination supplement instruction, the processor 102 performs processing after S58 in the procedure of FIG. 11. In this case, the processor 102 displays the import confirmation dialog 720 in a state where the link-destination main description in the tray file is input to the link destination input field 722, and receives an input of the subsequent portions of the link destination.

Condition Designation for Link Destination to be Input by Import Side

In the above-described example, in a case where the import-side user is caused to designate the folder as the link destination of the tray, the flow designer inputs a description indicating a condition to be satisfied by the folder (see the description field 530 on the tray editing screen 500 in FIG. 9). The description refers to a condition imposed on a user as an import destination by the flow designer, and in import, the user designates the folder as the link destination, which satisfies the condition. However, there is no guarantee that the import-side user designates an appropriate folder that satisfies the condition indicated by the description as the link destination.

As another example for this, the import-side application may check whether or not the folder as the link destination designated by the import-side user satisfies the condition designated by the flow designer.

In this example, the flow designer inputs the condition to be satisfied by the folder designated as the link destination by the import-side user, on the tray editing screen 500. The description field 530 on the tray editing screen 500 in FIG. 9 is used for inputting a human-oriented description as a text string. On the contrary, in this example, the input of the clear condition allowed to be determined by the processor 102 is received. Examples of such a condition include a condition of designating which folder on the folder tree the folder as the link destination to be designated is at a lower level or a condition to be satisfied by the name of the folder as the link destination to be designated.

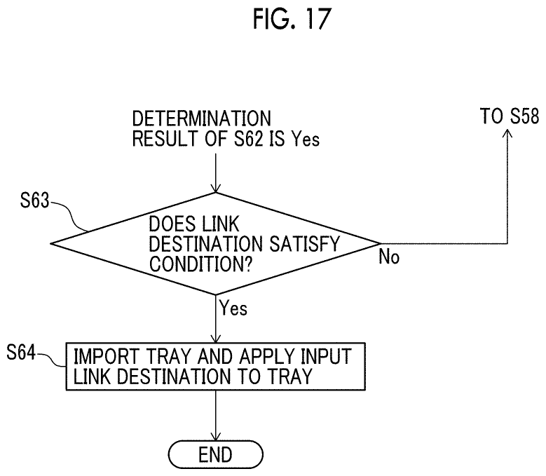

FIG. 17 illustrates a portion of a procedure performed by the processor 102 of the PC on the import side in a case where the tray file including information of such a condition is imported. That is, the procedure performed by the processor 102 in this case is obtained by changing the processes after S58 in the procedure illustrated in FIG. 11 to processes illustrated in FIG. 17.

In this procedure, in a case where the processor 102 determines that the link destination is input from the user in S62, the processor 102 determines whether or not the link destination satisfies the condition in the tray file (S63). In a case where the determination result is Yes, the tray in which the path of the input link destination is set is imported to the PC (S64). In a case where the determination result of S63 is No, the processor 102 causes the process to return to S58 and receives the re-input of the link destination.

In the above-described exemplary embodiment, the PC of each user executes the application for the tray service. However, this is just an example. Instead, for example, a server that provides the tray service in a form of a web service may perform processing similar to the application.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a first information processing apparatus including a first processor configured to receive a creation instruction of representation information representing a storage area used for transferring data, from a first user, and create the representation information in accordance with the received creation instruction; and
a second information processing apparatus including a second processor,
wherein the created representation information includes designation information indicating whether or not to allow another user other than the first user to designate a location of the storage area,
the second processor is configured to receive the representation information which represents the storage area used for transferring data and include the designation information indicating whether or not to allow a user to designate the location of the storage area, and
in a case where the designation information included in the representation information indicates that the user is allowed to designate the location of the storage area, the second processor displays a screen for receiving designation of the location and preserves the representation information incorporating information of the location, which is designated on the screen.

2. An information processing apparatus comprising:
a processor configured to receive a creation instruction of representation information representing a storage area used for transferring data, from a first user, and
create the representation information in accordance with the received creation instruction,
wherein the created representation information includes designation information indicating whether or not to allow another user other than the first user to designate a location of the storage area.

3. The information processing apparatus according to claim 2,
wherein the creation instruction includes information partially indicating the location of the storage area, and
the representation information includes the designation information indicating that the other user other than the first user is allowed to partially designate the location of the storage area.

4. The information processing apparatus according to claim 3,
wherein the creation instruction includes information indicating a location in a middle of a path for specifying the location of the storage area, and
the representation information includes partial path information indicating a partial path from a start point of the path to the location in the middle of the path, and the designation information indicating that the other user other than the first user is allowed to designate the location of the storage area.

5. The information processing apparatus according to claim 2,
wherein the creation instruction includes condition information indicating a condition to be satisfied by a location designated as the location of the storage area by the other user, and
the representation information further includes the condition information.

6. The information processing apparatus according to claim 3,
wherein the creation instruction includes condition information indicating a condition to be satisfied by a location designated as the location of the storage area by the other user, and
the representation information further includes the condition information.

7. The information processing apparatus according to claim 4,
wherein the creation instruction includes condition information indicating a condition to be satisfied by a location designated as the location of the storage area by the other user, and
the representation information further includes the condition information.

8. The information processing apparatus according to claim 5,
wherein the condition information refers to description information displayed in association with a screen for inputting the location of the storage area displayed in a terminal of the other user in a case where the other user registers the representation information in the terminal of the other user.

9. The information processing apparatus according to claim 6,
wherein the condition information refers to description information displayed in association with a screen for inputting the location of the storage area displayed in a terminal in a case where the other user registers the representation information in the terminal of the other user.

10. The information processing apparatus according to claim 7,
wherein the condition information refers to description information displayed in association with a screen for inputting the location of the storage area displayed in a terminal in a case where the other user registers the representation information in the terminal of the other user.

11. The information processing apparatus according to claim 5,
wherein the condition information refers to information used for determining whether or not the location of the storage area, which is input from the other user to a terminal of the other user satisfies the condition, in a case where the other user registers the representation information in the terminal of the other user.

12. The information processing apparatus according to claim 6,
wherein the condition information refers to information used for determining whether or not the location of the storage area, which is input from the other user to a terminal of the other user satisfies the condition, in a case where the other user registers the representation information in the terminal of the other user.

13. The information processing apparatus according to claim 7,
wherein the condition information refers to information used for determining whether or not the location of the storage area, which is input from the other user to a terminal of the other user satisfies the condition, in a case where the other user registers the representation information in the terminal of the other user.

14. The information processing apparatus according to claim 2,
wherein the creation instruction includes an input of path information indicating a path for specifying the location from the first user, and
the representation information includes the path information and the designation information indicating that the other user other than the first user is not allowed to designate the location of the storage area.

15. The information processing apparatus according to claim 2,
wherein the creation instruction includes a designation of a location which does not exist as the location, and
the representation information includes information regarding creation of the non-existing storage area by the other user other than the first user.

16. The information processing apparatus according to claim 3,
wherein the creation instruction includes a designation of a location which does not exist as the location, and
the representation information includes information regarding creation of the non-existing storage area by the other user other than the first user.

17. The information processing apparatus according to claim 4,
wherein the creation instruction includes a designation of a location which does not exist as the location, and
the representation information includes information regarding creation of the non-existing storage area by the other user other than the first user.

18. The information processing apparatus according to claim 5,
wherein the creation instruction includes a designation of a location which does not exist as the location, and
the representation information includes information regarding creation of the non-existing storage area by the other user other than the first user.

19. The information processing apparatus according to claim 2,
wherein the creation instruction includes information regarding an order of the storage area in the transfer, and
the representation information includes the information regarding the order.

20. A non-transitory computer readable medium storing a program causing a computer to perform:
receiving representation information which represents a storage area used for transferring data and includes designation information indicating whether or not to allow a user to designate a location of the storage area; and
in a case where the designation information in the representation information indicates that the user is allowed to designate the location of the storage area, displaying a screen for receiving designation of the location and preserving the representation information incorporating information of the location designated on the screen.
